(19) United States
(12) Patent Application Publication
(10) Pub. No.: US 2013/0191786 A1
(43) Pub. Date: Jul. 25, 2013

(54) METHOD OF PERFORMING A SWITCHING OPERATION THROUGH A GESTURE INPUTTED TO AN ELECTRONIC DEVICE

(71) Applicant: Hsi-Lin Kuo, New Taipei City (TW)

(72) Inventor: Hsi-Lin Kuo, New Taipei City (TW)

(21) Appl. No.: 13/353,329

(22) Filed: Jan. 19, 2012

(51) Int. Cl. G06F 3/033; G06F 3/048

(52) U.S. Cl. 715/846; 715/863

(57) ABSTRACT

A method of performing a switching operation through a gesture inputted to an electronic device includes determining whether a current user interface of the electronic device is a predetermined user interface, where the predetermined user interface is a non-interactive user interface without prompting to input the gesture for performing the switching operation; capturing the gesture inputted to the predetermined user interface of the electronic device; determining whether the captured gesture corresponds to a predetermined gesture; and performing a switching operation when the captured gesture corresponds to the predetermined gesture.

### BACKGROUND

1. Technical Field

The present invention relates to a method of performing a switching operation of an electronic device, and particularly to a method that can utilize a gesture inputted by a user to switch different authority levels or different user accounts of an electronic device.

2. Description of the Conventional Art

Most of people are willing to share non-private personal data (such as travel pictures, mood articles, and so on), but to intend to protect private personal data. In the present LOCK/UNLOCK operation of electronic devices, most electronic devices utilize a method combining an electronic device with technologies of biometrics (such as fingerprints and/or retinas of a user of the electronic device) to lock/unlock the electronic device, or utilize a predetermined coordinate trajectory on a predetermined user interface of an electronic device to lock/unlock the electronic device.

As shown in FIG. 1, when a predetermined finger 100 of a user touches a fingerprint identification device 102 of an electronic device 104, the fingerprint identification device 102 can identify a fingerprint of the predetermined finger 100 to determine whether the electronic device 104 is unlocked. As shown in FIG. 2, when a gesture 204 of a user on an UNLOCK user interface 200 of an electronic device 202 matches a predetermined coordinate trajectory, the electronic device 202 is unlocked.

However, the conventional art needs an exclusive identification means or an interactive user interface to lock/unlock or switch authority level of an electronic device. In addition, when the user utilizes an interactive user interface of an electronic device to lock/unlock or switch authority level of the electronic device, other people surrounding the electronic device can aware the lock/unlock or switching authority level operation, resulting in awkwardness being existed between the user and other people. Therefore, the conventional art is not traceless and convenient for a user to lock/unlock or switch authority level of an electronic device.

### SUMMARY

An embodiment provides a method of performing a switching operation through a gesture inputted to an electronic device. The method includes determining whether a current user interface of the electronic device is a predetermined user interface, where the predetermined user interface is a non-interactive user interface without prompting to input the gesture for performing the switching operation; capturing the gesture inputted to the predetermined user interface of the electronic device; determining whether the captured gesture corresponds to a predetermined gesture; performing the switching operation when the captured gesture corresponds to the predetermined gesture.

Another embodiment provides a method of performing a switching operation through a gesture inputted to an electronic device. The method includes creating an icon on a predetermined user interface of the electronic device; capturing the gesture inputted to the predetermined user interface of the electronic device; determining whether the captured gesture corresponds to a predetermined closed-loop gesture interacting with the icon; performing the switching operation when the captured gesture corresponds to the predetermined gesture interacting with the icon.

The present invention provides a method of performing a switching operation through a gesture inputted to an electronic device. The method utilizes a gesture inputted to a predetermined user interface/any user interface by the user to switch different authority levels of the electronic device, or to switch different user accounts of the electronic device, where the gesture corresponds to a predetermined gesture, or the gesture corresponds to a predetermined gesture interacting with an icon. Compared to the conventional art, because the present invention does not need an exclusive identification means or an interactive user interface to switch different authority levels of the electronic device, or to switch different user accounts of the electronic device, a user can trigger the switching operation of the electronic device performed in the background according to the gesture. That is to say, other people surrounding the electronic device may not be aware that the switching operation of the electronic device is performed. Thus, the present invention can let the user use the electronic device insensibly and conveniently.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a user of an electronic device utilizing a fingerprint identification device to unlock the electronic device.

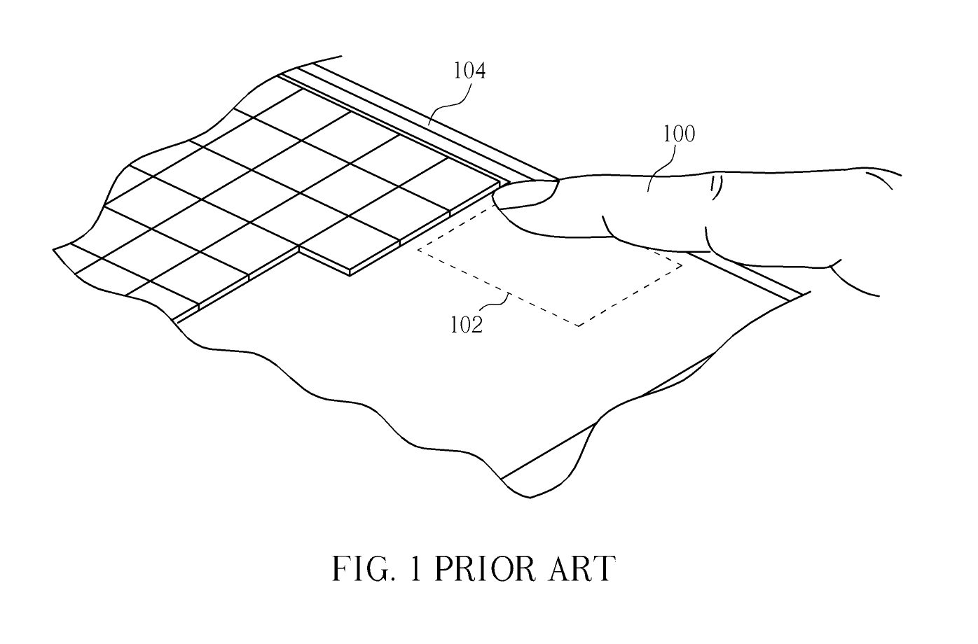

FIG. 2 is a diagram illustrating a user of an electronic device utilizing a predetermined coordinate trajectory on an UNLOCK user interface of the electronic device to unlock the electronic device.

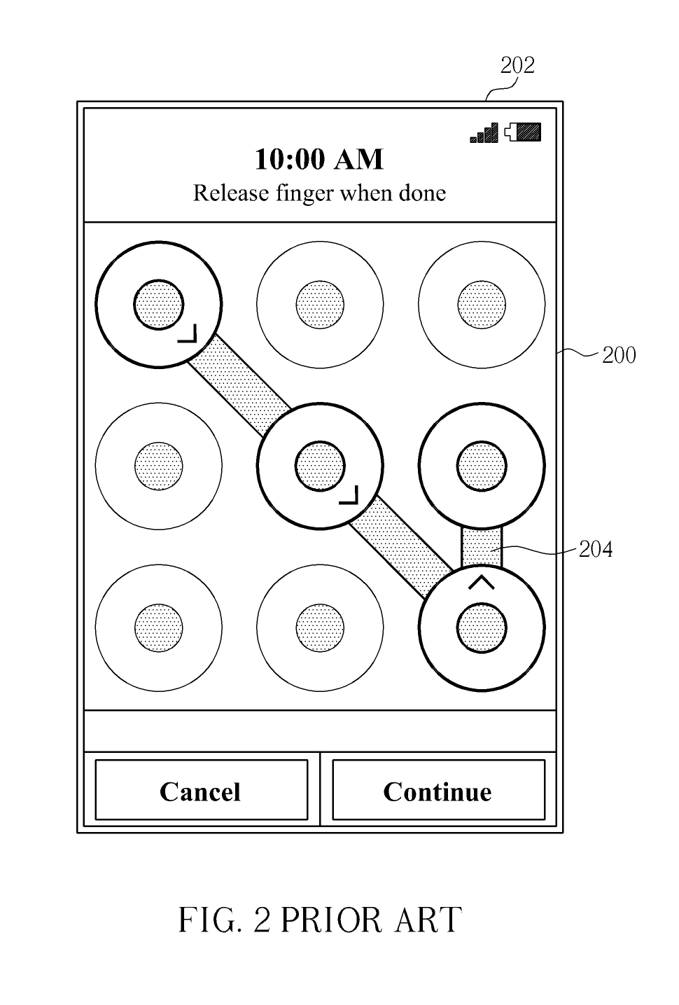

FIG. 3 is a flowchart illustrating a method of performing a switching operation through a gesture inputted to a non-interactive user interface for performing a switching operation of an electronic device according to an embodiment.

FIG. 4 is a diagram illustrating an interface of the electronic device when the authority level of the electronic device is switched to a power user level.

FIG. 5 is a diagram illustrating an interface of the electronic device when the authority level of the electronic device is switched to a restricted user level.

FIG. 6 is a diagram illustrating that a user can input a gesture to unlock the electronic device.

FIG. 7 is a diagram illustrating the predetermined gesture being a closed-path shape enclosing a predetermined icon on the predetermined user interface of the electronic device.

FIG. 8 is a diagram illustrating the predetermined gesture being an open-path shape on the predetermined user interface of the electronic device.

FIG. 9 is a diagram illustrating the predetermined gesture being a closed-path shape overlapping a predetermined icon on the predetermined user interface of the electronic device.

FIG. 10 is a flowchart illustrating a method of performing a switching operation through a gesture inputted to the electronic device according to another embodiment.

### DETAILED DESCRIPTION

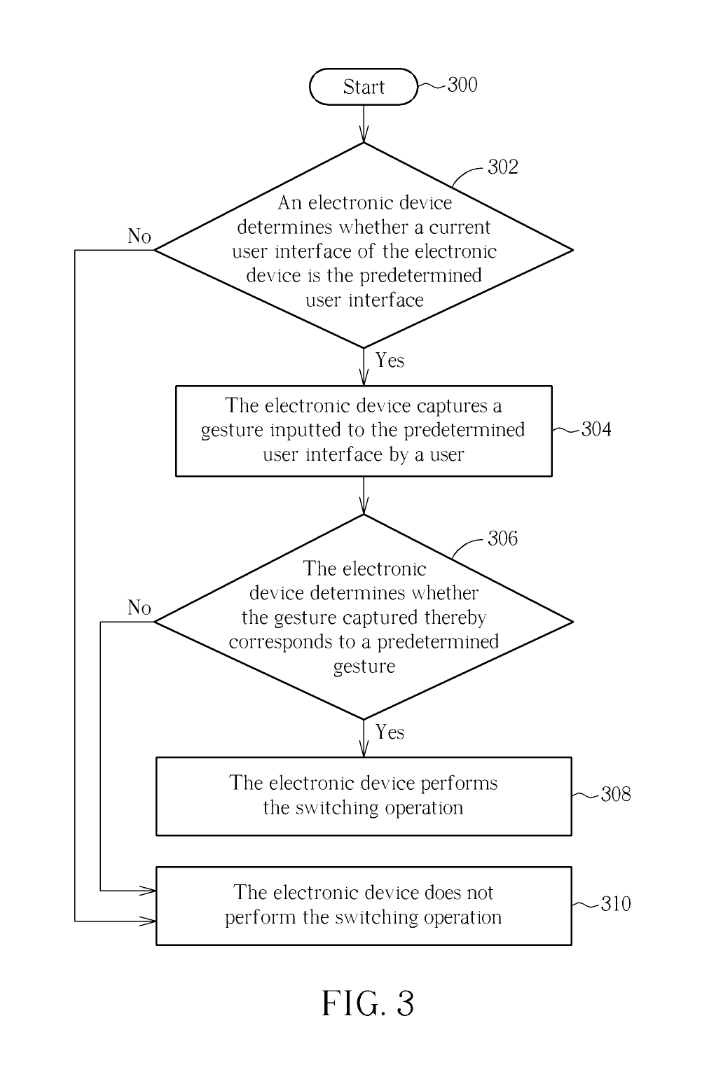

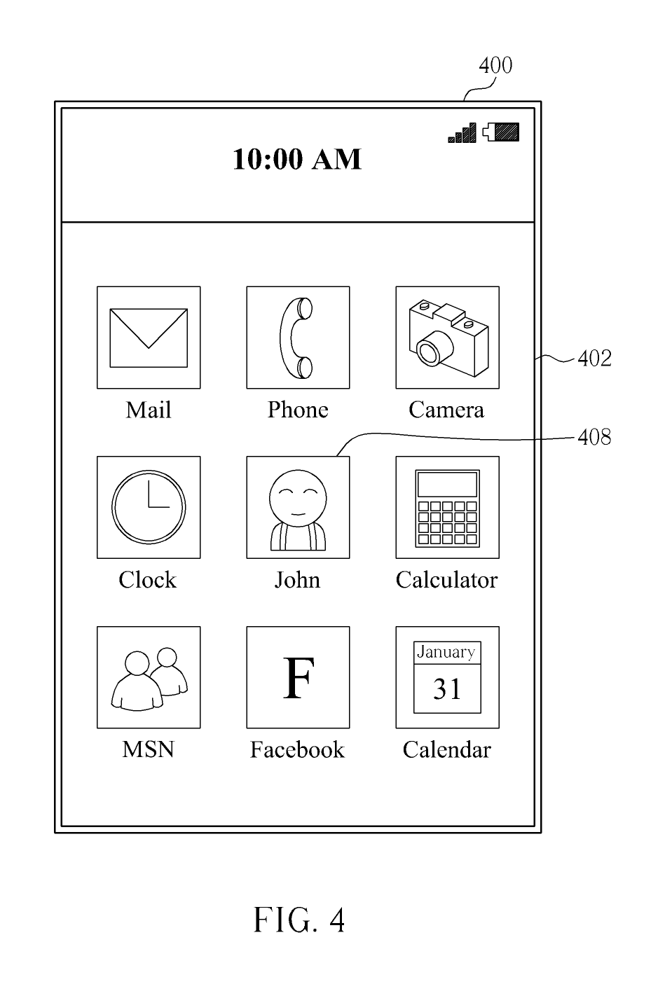

Please refer to FIG. 3 and FIG. 4. FIG. 3 is a flowchart illustrating a method of performing a switching operation through a gesture inputted to a non-interactive user interface for performing a switching operation of an electronic device 400 according to an embodiment, and FIG. 4 is a diagram illustrating the electronic device 400. Detailed steps are as follows:

Step 300: Start.

Step 302: An electronic device 400 determines whether a current user interface of the electronic device 400 is the predetermined user interface 402. If yes, go to Step 304; if no, go to Step 310.

Step 304: The electronic device 400 captures a gesture 406 inputted to the predetermined user interface 402 by a user.

Step 306: The electronic device 400 determines whether the gesture 406 captured thereby corresponds to a predetermined gesture.

If yes, go to Step 308; if no, go to Step 310.

Step 308: The electronic device 400 performs the switching operation.

Step 310: The electronic device 400 does not perform the switching operation.

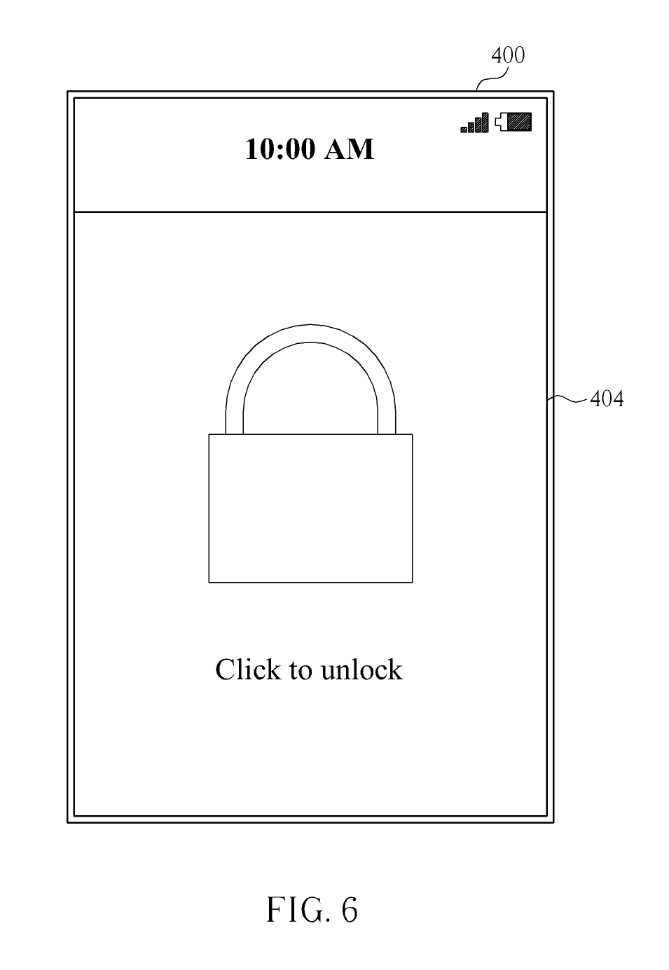

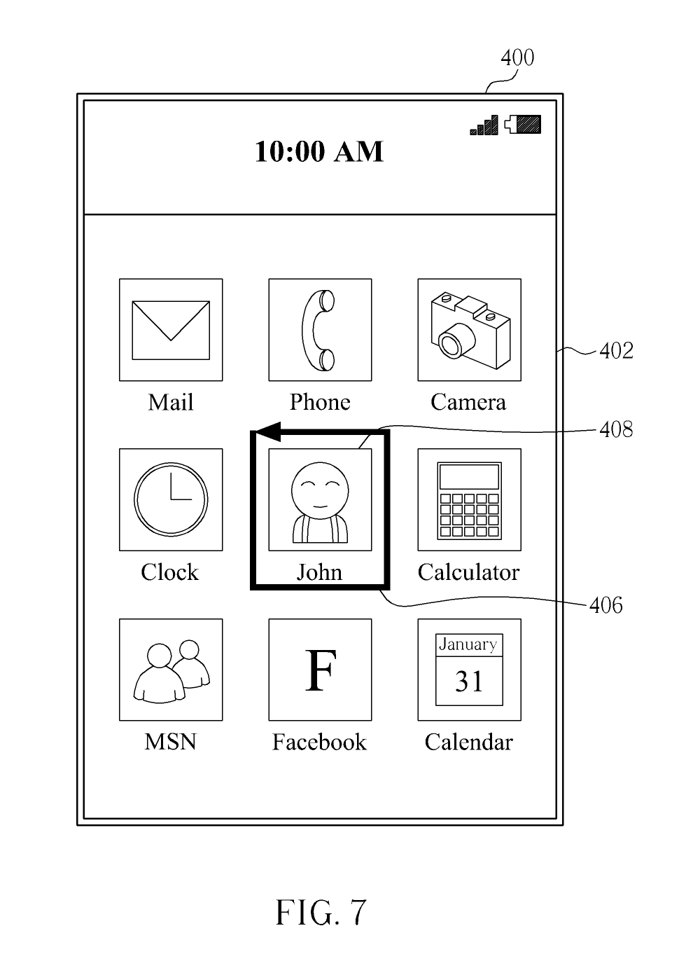

In Step 302, the predetermined user interface 402 may be a non-interactive interface without prompting to input a predetermined gesture for performing the switching operation. For example, the predetermined user interface 402 is a “home screen” interface showing a plurality of icons, each of which for performing another operation other than the switching operation, such as camera, calculator, calendar, etc., in the event of a gesture other than the predetermined gesture being inputted in relation with said icons. However, the predetermined user interface 402 of the present invention may also be an interactive interface without prompting to input a gesture in order for performing the switching operation. For example, the predetermined user interface is an “UNLOCK” interface 404 of the electronic device 400, whereby a user can input a gesture to unlock the electronic device 400 (as shown in FIG. 6) and/or performing the switching operation. In Step 304, as shown in FIG. 7, the electronic device 400 can capture the gesture 406 inputted to the predetermined user interface 402 by the user (the stroke of the gesture 406 is not necessarily shown on the predetermined user interface 402), where the gesture 406 inputted to the predetermined user interface 402 by the user does not correspond to any operation other than the switching operation. In addition, the gesture 406 inputted to the predetermined user interface 402 by the user can be a mouse gesture or a touch gesture. That is to say, the user can utilize a mouse to input the gesture 406 to the predetermined user interface 402, or inputs the gesture 406 to the predetermined user interface 402 with one or more fingers contacting a touch screen of the electronic device 400. In Step 306, when the user utilizes the mouse or have one or more fingers contacting the touch screen of the electronic device 400 to input the gesture 406 to the predetermined user interface 402, the electronic device 400 can determine whether the gesture 406 captured thereby corresponds to a predetermined gesture. In Step 308, when the electronic device 400 determines that the gesture 406 captured thereby corresponds to the predetermined gesture, the electronic device 400 will perform the switching operation.

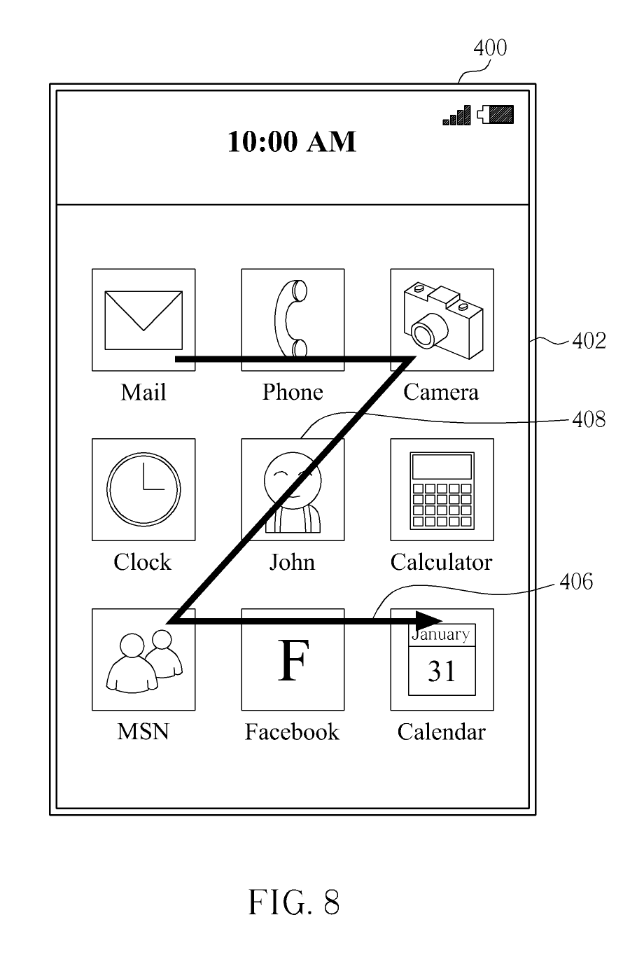

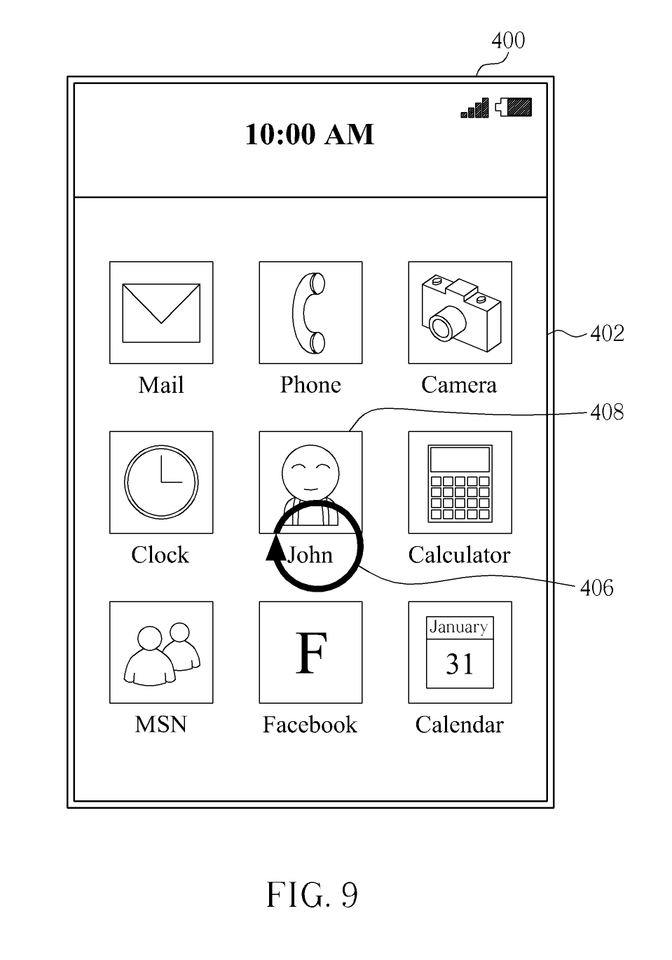

The predetermined gesture can be an open-path shape (such as a Z shape as shown in FIG. 8), or a closed-path shape (such as a rectangle shown in FIG. 7 or a circle shown in FIG. 9). However, the present invention is not limited to the open-path shape being the Z shape and the closed-path shape being the rectangle or the circle. For another example, the predetermined gesture can be a closed-path shape with at least one stroke, such as a polygon.

In another embodiment, the predetermined gesture is a closed-path shape enclosing (as shown in FIG. 7) or overlapping (as shown in FIG. 9) a predetermined icon 408 on the predetermined user interface 402 of the electronic device 400, where the predetermined icon 408 can be any icon set or created by the user.

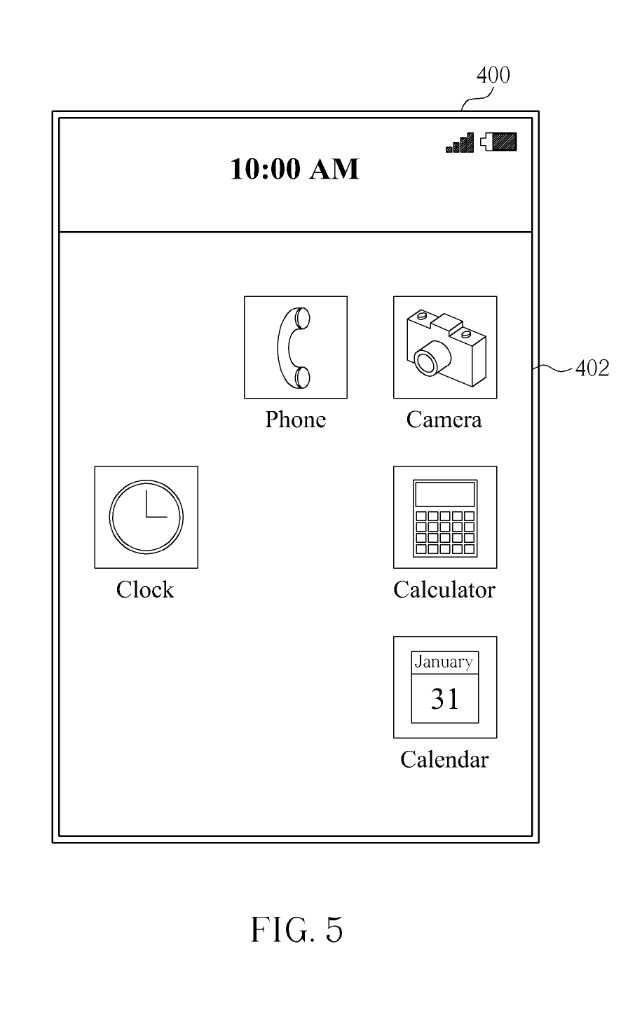

The switching operation may include, but not limited to, an authority level switching operation or a user account switching operation. For example, when the electronic device 400 determines that the gesture 406 captured thereby corresponds to the predetermined gesture, the electronic device 400 can switch the authority level of the electronic device 400 from a power user to a restricted user, or from a restricted user to a power user. Therefore, as shown in FIG. 4, when the authority level of the electronic device 400 is the power user level, the user can see all icons displayed on the predetermined user interface 402 of the electronic device 400 and perform a respective operation of a corresponding program by inputting another gesture, other than the predetermined gesture, interacting with one of the icons, such as run a program by clicking or touching on one of the icons. However, as shown in FIG. 5, when the authority level of the electronic device 400 is switched to the restricted user level, the user only can see a restrictive set of the icons displayed on the predetermined user interface 402 of the electronic device 400 and perform a respective operation of a corresponding program by inputting another gesture, other than the predetermined gesture, interacting with one of the restrictive set of the icons. That is to say, when the authority level of the electronic device 400 is switched to the restricted user level, the electronic device 400 can hide a predetermined file displayed on the predetermined user interface 402 (as shown in FIG. 5); when the authority level of the electronic device 400 is switched to the power user level, the electronic device 400 can display all files on the predetermined user interface 402 (as shown in FIG. 4). In another embodiment, when the electronic device 400 determines that the gesture thereby corresponds to the predetermined gesture, the electronic device 400 can switch from current user account to another user account of the electronic device 400.

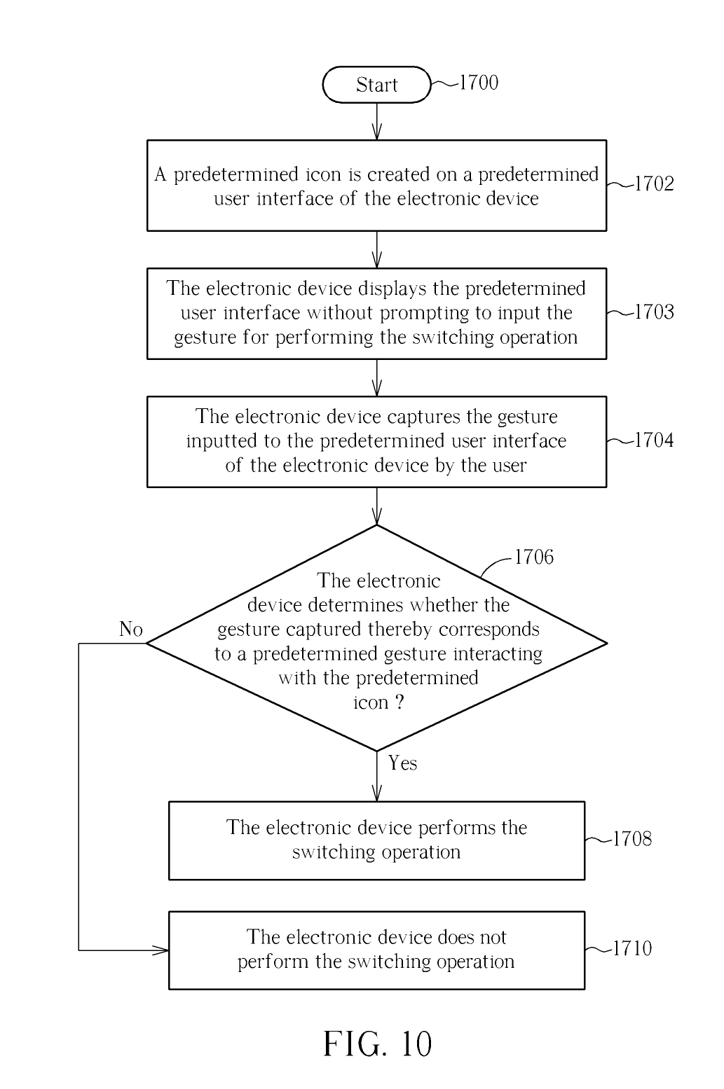

Please refer to FIG. 10, FIG. 4, FIG. 7, FIG. 8, and FIG. 9. FIG. 10 is a flowchart illustrating a method of performing a switching operation through a gesture inputted to the electronic device 400 according to another embodiment. Detailed steps are as follows:

Step 1700: Start.

Step 1702: A predetermined icon 408 is created on a predetermined user interface 402 of the electronic device 400.

Step 1703: The electronic device 400 displays the predetermined user interface 402 without prompting to input the gesture 406 for performing the switching operation.

Step 1704: The electronic device 400 captures the gesture 406 inputted to the predetermined user interface 402 of the electronic device 400 by the user.

Step 1706: The electronic device 400 determines whether the gesture 406 captured thereby corresponds to a predetermined gesture interacting with the predetermined icon 408. If yes, go to Step 1708; if no, go to Step 1710.

Step 1708: The electronic device 400 performs the switching operation.

Step 1710: The electronic device 400 does not perform the switching operation.

A difference between the embodiment in FIG. 10 and the embodiment in FIG. 3 is that in Step 1702, the predetermined icon 408 is created on the predetermined user interface 402 of the electronic device 400 (as shown in FIG. 4, the predetermined icon 408 is created on the predetermined user interface 402 of the electronic device 400), in Step 1706, the electronic device 400 determines whether the gesture 406 captured thereby corresponds to the predetermined gesture interacting with the predetermined icon 408, where in Step 1706, the predetermined gesture interacting with the predetermined icon 408 is an open-path shape with at least one stroke thereof overlapping the predetermined icon 408 (as shown in FIG. 8), is a closed-path shape enclosing the predetermined icon 408 (as shown in FIG. 7), or is a closed-path shape overlapping the predetermined icon 408 (as shown in FIG. 9). Therefore, in Step 1708, when the electronic device 400 determines the gesture 406 captured thereby corresponds to the predetermined gesture interacting with the predetermined icon 408, the electronic device 400 can perform the switching operation. Subsequent operational principles of the embodiment in FIG. 10 are the same as those of the embodiment in FIG. 3, so further description thereof is omitted for simplicity.

In yet another embodiment of the present invention, the switching operation as shown in FIG. 3 or FIG. 10 is performed in the background of the electronic device 400, therefore the user and other people surrounding the electronic device 400 may not aware that the switching operation of the electronic device 400 is performed.

In yet another embodiment of the present invention, the switching operation as shown in FIG. 3 or FIG. 10 is performed in the background of the electronic device 400. Then, the electronic device 400 can vibrate and/or flash instantaneously to notice the user that the switching operation as shown in FIG. 3 or FIG. 10 is performed. Therefore, only other people surrounding the electronic device 400 may not aware that the switching operation of the electronic device 400 is performed, but, the user can aware that the switching operation of the electronic device 400 is performed.

To sum up, the method of performing a switching operation through a gesture inputted to an electronic device utilizes a gesture inputted to a predetermined user interface/any user interface of the electronic device by the user to switch different authority levels of the electronic device, or to switch different user accounts of the electronic device, where the gesture corresponds to a predetermined gesture, or the gesture corresponds to a predetermined gesture interacting with an predetermined icon. Compared to the conventional art, because the present invention does not need an exclusive identification device or the UNLOCK user interface to switch different authority levels of the electronic device, or to switch different user accounts of the electronic device, a user can trigger the switching operation of the electronic device performed in the background according to the gesture. That is to say, other people surrounding the electronic device may not be aware that the switching operation of the electronic device is performed. Thus, the present invention can let the user use the electronic device insensibly and conveniently.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of performing a switching operation through a gesture inputted to an electronic device, the method comprising:
determining whether a current user interface of the electronic device is a predetermined user interface, wherein the predetermined user interface is a non-interactive user interface without prompting to input the gesture for performing the switching operation;
capturing the gesture inputted to the predetermined user interface of the electronic device;
determining whether the captured gesture corresponds to a predetermined gesture; and
performing a switching operation when the captured gesture corresponds to the predetermined gesture.

2. The method of claim 1, wherein performing the switching operation when the captured gesture corresponds to the predetermined gesture comprises:
switching between different authority levels of the electronic device.

3. The method of claim 2, wherein switching between the different authority levels of the electronic device is switching the authority level of the electronic device between a power user and a restricted user.

4. The method of claim 1, wherein the non-interactive user interface shows no stroke path of the inputted gesture.

5. The method of claim 1, wherein performing the switching operation when the captured gesture corresponds to the predetermined gesture comprises:
hiding/unhiding a predetermined file displayed on the user interface of the electronic device.

6. The method of claim 1, wherein performing the switching operation when the captured gesture corresponds to the predetermined gesture comprises:
switching between different user accounts of the electronic device.

7. The method of claim 1, wherein the gesture inputted to the non-interactive user interface of the electronic device does not correspond to any operation other than the switching operation.

8. The method of claim 1, wherein the predetermined gesture is an open-path shape.

9. The method of claim 1, wherein the predetermined gesture is a closed-path shape.

10. The method of claim 9, wherein the predetermined gesture is a closed-path shape enclosing a predetermined icon on the non-interactive user interface of the electronic device.

11. The method of claim 1, wherein the predetermined gesture is a closed-path shape with at least one stroke thereof overlapping a predetermined icon on the non-interactive user interface of the electronic device.

12. The method of claim 1, wherein the gesture is a mouse gesture or a touch gesture.

13. The method of claim 1, wherein performing the switching operation when the captured gesture corresponds to the predetermined gesture is performing the switching operation in the background of the electronic device when the captured gesture corresponds to the predetermined gesture.

14. A method of performing a switching operation through a gesture inputted to an electronic device, the method comprising:
creating a predetermined icon on a predetermined user interface of the electronic device;
capturing the gesture inputted to the predetermined user interface of the electronic device;
determining whether the captured gesture corresponds to a predetermined gesture interacting with the predetermined icon; and
performing a switching operation when the captured gesture corresponds to the predetermined gesture interacting with the predetermined icon.

15. The method of claim 1, further comprising:
displaying the predetermined user interface without prompting to input the gesture for performing the switching operation.

16. The method of claim 14, wherein the predetermined gesture interacting with the predetermined icon is an open-path shape with at least one stroke thereof overlapping the predetermined icon.

17. The method of claim 14, wherein the predetermined gesture interacting with the predetermined icon is a closed-path shape enclosing the predetermined icon.

18. The method of claim 14, wherein the predetermined gesture interacting with the predetermined icon is a closed-path shape with at least one stroke thereof overlapping the predetermined icon.
